(19) United States
(12) Patent Application Publication
(10) Pub. No.: US 2013/0076170 A1
(43) Pub. Date: Mar. 28, 2013

(54) Stator for electric machine

(71) Applicants: Rodwan T. Adra, Peoria, IL (US); William J. Hardin, Metamora, IL (US); Zakdy Sorchini, Beavercreek, OH (US)

(72) Inventors: Rodwan T. Adra, Peoria, IL (US); William J. Hardin, Metamora, IL (US); Zakdy Sorchini, Beavercreek, OH (US)

(73) Assignee: Caterpillar Inc., Peoria, IL (US)

(21) Appl. No.: 13/245,900

(22) Filed: Sep. 27, 2011

(51) Int. Cl. H02K 3/24

(52) U.S. Cl. 310/59

(57) ABSTRACT

An electric machine having a stator, the stator including a stator core of substantially annular shape. The stator core includes a plurality of stator poles protruding in a radial direction. A stator winding is wound around each of the stator poles. The stator winding have multiple coils and an end turn positioned at each axial end. Further, the stator winding having a gap defined between adjacent coils at the end turns to allow a cooling fluid to pass through.

### TECHNICAL FIELD

The present disclosure relates to an electric machine, and particularly to a switched reluctance motor with an improved cooling performance.

### BACKGROUND

Electric machines, such as, switched reluctance motors are extensively used as direct-drive energy transducers. However, during operation, temperature of various components in the electric machine may rise. Specifically, the temperature of a stator winding in a stator may rise as a result of ohmic or resistive heating. The electric machine may employ a cooling system which uses a cooling fluid circulating around the various components of the electric machine. However, the cooling system may not be effective for cooling of coils of the stator winding, because of inner faces of the coils not being in direct reach of the cooling fluid.

United States Patent Application No. 20040100154 discloses an electric motor using cooling tubes positioned between stator slots. The electric motor includes a stator having a plurality of stator teeth, each of the stator teeth having a trapezoidal cross section. The stator teeth are spaced apart from adjacent stator teeth by the stator slot. A winding coil is surrounding each of the stator teeth and occupies a portion of the stator slot, leaving an unoccupied remainder portion of the stator slot. The cooling tube is positioned in the unoccupied remainder portion of each stator slot.

### SUMMARY

In one aspect, the present disclosure provides a stator for an electric machine. The stator includes a stator core having a plurality of stator poles protruding in a radial direction. The stator further includes a stator winding wound around each of the stator poles, the stator winding having multiple coils and an end turn positioned at an axial end thereof. The stator winding includes a gap provided between the adjacent coils at the end turns to allow a cooling fluid to pass.

In another aspect, the present disclosure provides a method of cooling the electric machine having the stator, in which the stator includes the stator winding disposed over the stator pole, the stator winding having multiple coils. The method includes defining the gaps between the adjacent coils. Further, the method includes passing a cooling fluid over the stator, such that the cooling fluid impinges on the inner faces of the coils by flowing through the gaps.

Other features and aspects of this disclosure will be apparent from the following description and the accompanying drawings.

### BRIEF DESCRIPTION OF THE DRAWINGS

FIG. 1 illustrates a sectional view of an electric machine;

FIG. 2 illustrates a partial perspective view of a stator of the electric machine of FIG. 1;

FIG. 3 illustrates a partial sectional view of a stator winding, according to an embodiment of the present disclosure;

FIG. 4 illustrates a partial sectional view of the stator winding, according to another embodiment of the present disclosure;

FIG. 5 illustrates a partial sectional view of the stator winding, according to another embodiment of the present disclosure;

FIG. 6 illustrates a partial sectional view of the stator winding, according to another embodiment of the present disclosure;

FIG. 7 illustrates a partial sectional view of the stator winding, according to another embodiment of the present disclosure;

FIG. 8 illustrates a partial sectional view of the stator winding, according to yet another embodiment of the present disclosure; and

FIG. 9 illustrates a flow diagram for a method of cooling the electric machine.

### DETAILED DESCRIPTION

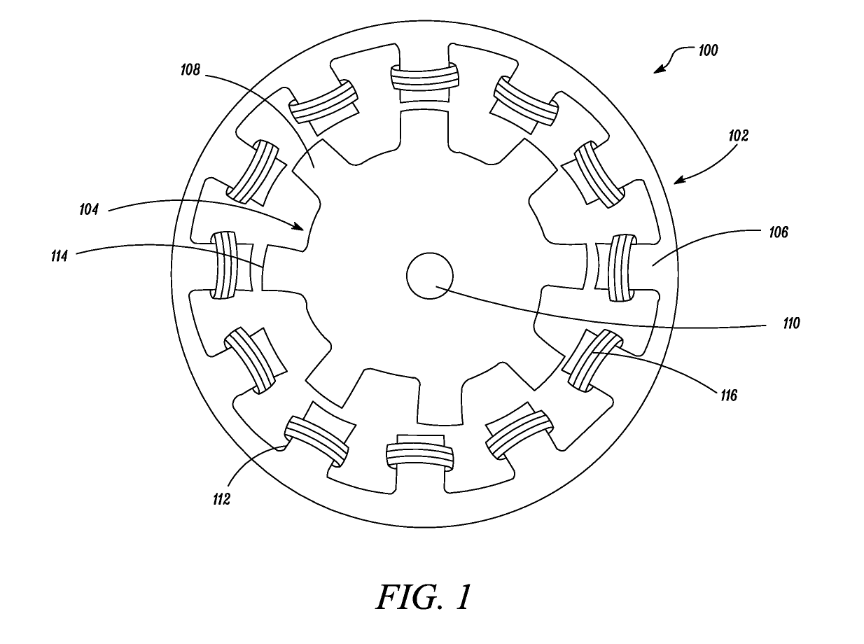

The present disclosure will now be described in detail with reference being made to accompanying figures. FIG. 1 illustrates a cross-sectional view of an electric machine 100, according to an aspect of the present disclosure. The electric machine 100 is typically employed in a vehicle, for example, a dozer, a motor-grader, an off-highway truck, an excavator, a loader or the like. However, it may be understood that, the electric machine 100 may be employed for various other applications like driving pumps, compressors, fans, power tools, industrial machinery, etc.

In one embodiment, the electric machine 100 may be employed as an electric motor converting electrical energy into mechanical energy. Alternatively, the electric machine 100 may act as an electric generator converting the mechanical energy into the electrical energy. The disclosed embodiments are illustrated, exemplifying the electric machine 100 as a switched reluctance motor, which runs by reluctance torque generated by providing an electric current to the electric machine.

In a typical configuration, the electric machine 100 may include a stator 102 and a rotor 104. While the stator 102 and the rotor 104 are illustrated as having cylindrical shape, it may be contemplated that the stator 102 and the rotor 104 may be of any other suitable shape. In the illustrated embodiment, the rotor 104 is housed inside the stator 102. Alternatively, the stator 102 may be housed inside the rotor 104. The stator 102 may be fixedly mounted in a housing (not illustrated) of the electric machine 100. The stator 102 may include a plurality of circumferentially spaced recesses configured to receive bolts, pins or other fasteners (not illustrated) for mounting the stator 102 in the housing of the electric machine 100. Further, the rotor 104 may be operatively housed with respect to the stator 102, such that the rotor 104 is rotatable relative to the stator 102 in the electric machine 100.

The stator 102 may include a stator core 106 formed by laminating a plurality of magnetically permeable sheets of material, for example, iron, cobalt, nickel, or any other high permeability metal or alloy thereof. Similarly, the rotor 104 may include a rotor core 108 formed of magnetically permeable sheets. The magnetically permeably sheets may be stacked together and suitably joined to one another by means conventionally known in the art. Further, the rotor 104 may be disposed in a substantially concentric relation to the stator core 106. The rotor 104 may include a bore 110, through which a shaft may extend for connection to a load. The stator 102 may be configured to generate a magnetic flux proportional to the supplied electric current, which may cause rotation of the rotor 104, which in turn drives the shaft.

In an embodiment, the stator 102 may further include a plurality of stator poles 112, circumferentially disposed at predetermined intervals from each other. Similarly, the rotor 104 may include a plurality of rotor poles 114 circumferentially disposed at predetermined intervals. In the illustrated embodiment, the stator poles 112 are protruding radially inwardly from the stator core 106. Similarly, the rotor poles 114 are illustrated protruding radially outwardly from the rotor core 108. However a person skilled in the art may understand that, the stator poles 112 or the rotor poles may be differently configured in the electric machine 100. Further, the stator poles 112 and the rotor poles 114 may be in equal or different in width from each other.

Further, a plurality of stator windings 116 are disposed over the stator poles 112. In the illustrated embodiment, each of the stator poles 112 may include a stator winding 116. The stator winding 116 may be wound around the stator poles 112 protruding as a bundle. In the electric machine 100, each of the stator windings 116 may be identical or different in shape from each other. Each of the stator winding 116 may be disposed over the stator poles 112 with a space therebetween. In the electric machine 100, the stator winding 116 is energized to create a magnetic field which provides a torque to cause rotation of the rotor 104, which in turn may impart a rotary motion to the load. In an alternative embodiment, the rotor 104 may have windings disposed over the rotor poles 114.

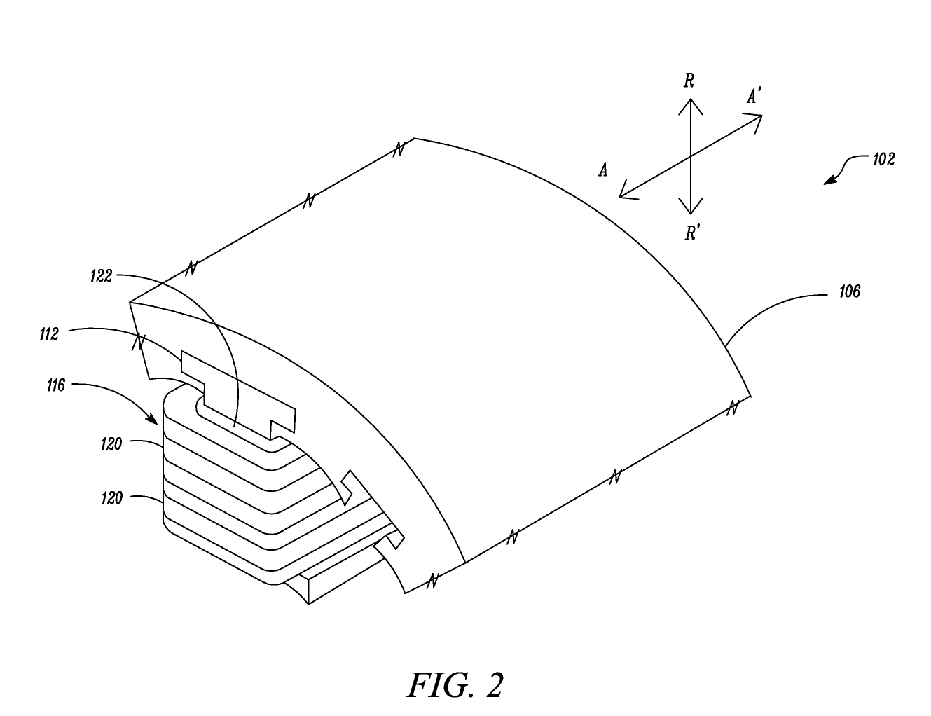

FIG. 2 illustrates a partial perspective view of the stator 102 of the electric machine 100 of FIG. 1. The stator winding 116 may have an annular shape and formed by successively winding an electrically conductive wire over the stator pole 112. Alternatively, the stator winding 116 may be formed of a plurality of individual electrically conductive wires overlapping each other. The electrically conductive wire may be, but not limited to, a copper wire, an aluminum wire, or the like.

As illustrated, the stator winding 116 may be extending in a radial direction R-R′ as well as an axial direction A-A′ of the electric machine 100. The stator winding 116 may include multiple coils 120 arranged in the radial direction R-R′ and further stacked one above the other in the axial direction A-A′. In an embodiment, the coils 120 may include end turns 122 disposed at the axial ends of the stator winding 116 along the axial direction A-A′. The coils 120 may have a curvilinear profile at the end turns 122. In the electric machine 100, the electric current is supplied to the stator winding 116 passing through the coils 120 to generate the magnetic flux. In order to avoid short-circuiting between the coils 120, the coils 120 may be electrically insulated from each other in the stator winding 116.

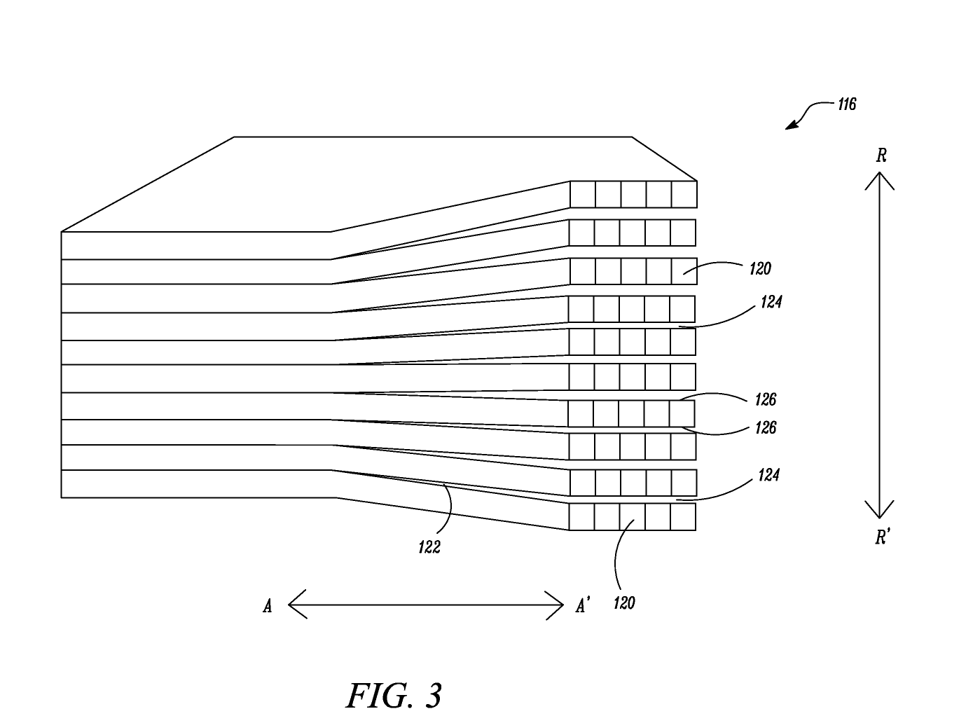

FIGS. 3-5 illustrate various views of the stator winding 116, in accordance with different embodiments of the present disclosure. In the illustrated embodiments, the coils 120 are spaced apart from each other at the end turns 122. The space between the adjacent coils 120 may define a plurality of gaps 124 in the stator winding 116. The gaps 124 may allow exposing of inner faces 126 of the coils 120 to a cooling fluid. In an embodiment, the cooling fluid may include air generated from a blower, or an auxiliary fan associated to the electric machine 100. In other embodiments, the cooling fluid may include a lubricant or cooling water that may be impinged on the coils 120 of the stator windings 116.

Specifically, FIG. 3 illustrates a sectional view of the stator winding 116, according to an embodiment of the present disclosure. As illustrated, the stator winding 116 may include the gaps 124 defined between the coils 120 along the radial direction R-R′. This may lead to exposing of the inner faces 126 along the radial direction R-R′ in the stator winding 116 to the cooling fluid.

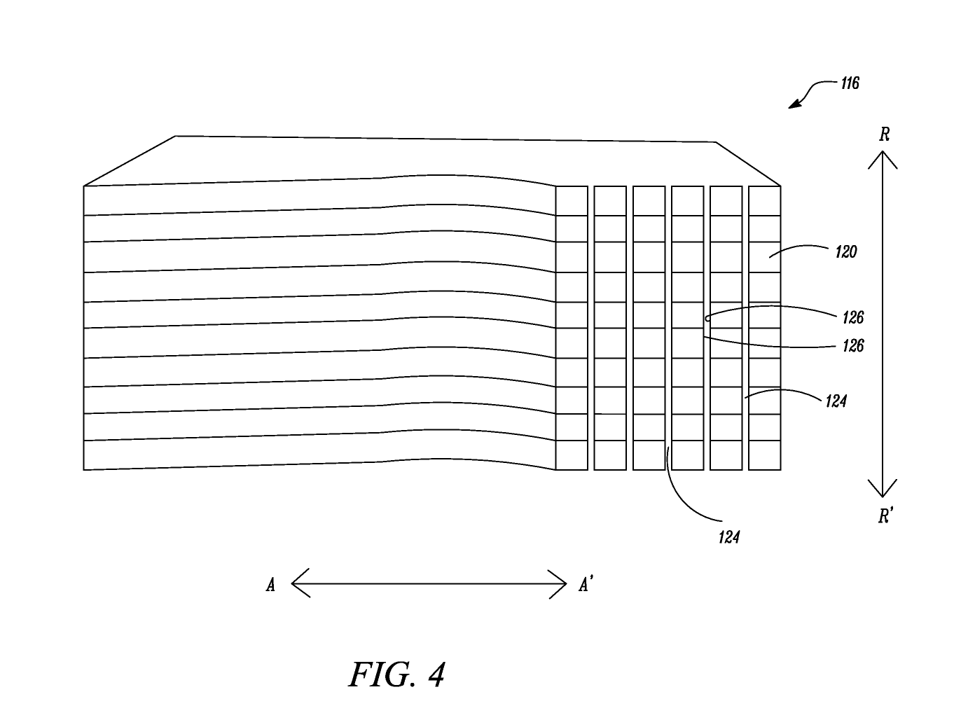

FIG. 4 illustrates a sectional view of the stator winding 116, according to another embodiment of the present disclosure. As illustrated, the stator winding 116 may include the gaps 124 defined between the coils 120 along the axial direction A-A′. This may lead to exposing of the inner faces 126 along the axial direction A-A′ in the stator winding 116 to the cooling fluid.

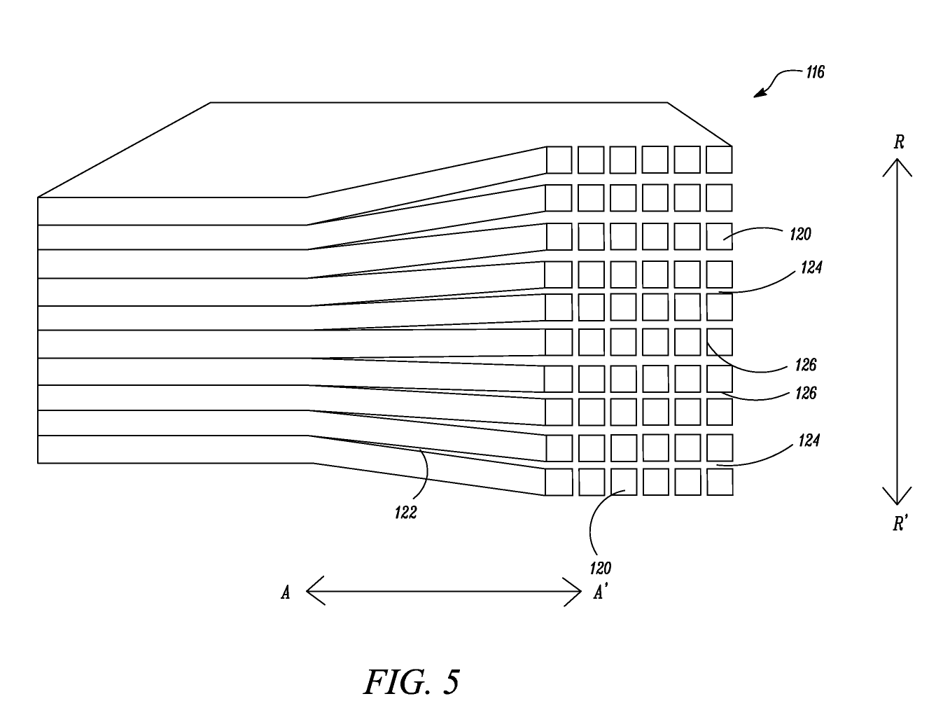

Moving on, FIG. 5 illustrates an embodiment of the stator winding 116 with the gaps 124 defined in both the radial direction R-R′ and the axial direction A-A′. This may lead to exposing of the inner faces 126 along the radial direction R-R′ as well as the axial direction A-A′ in the stator winding 116 to the cooling fluid.

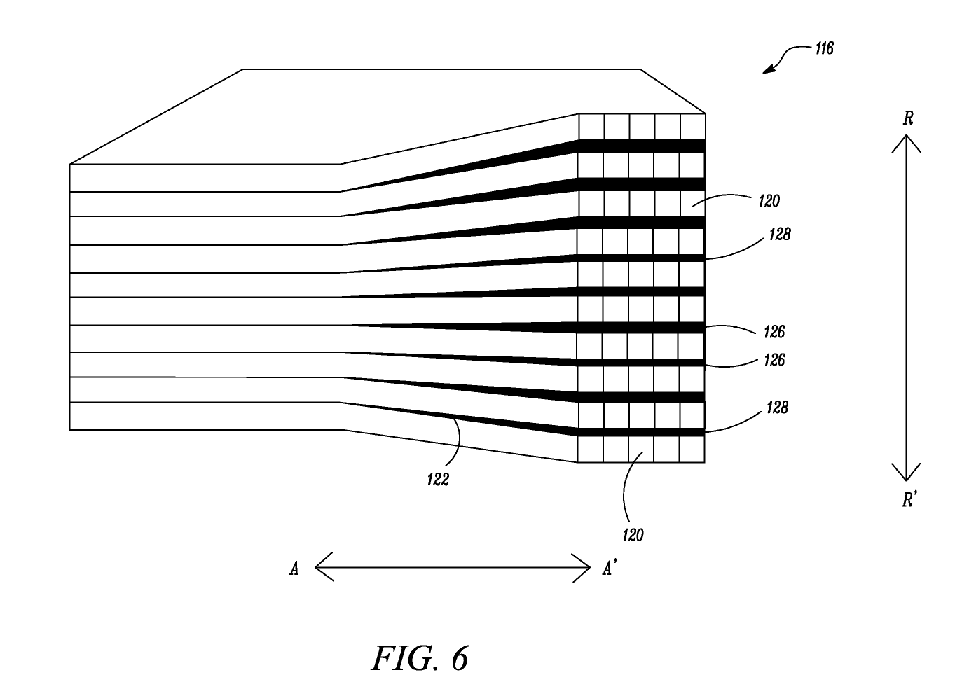

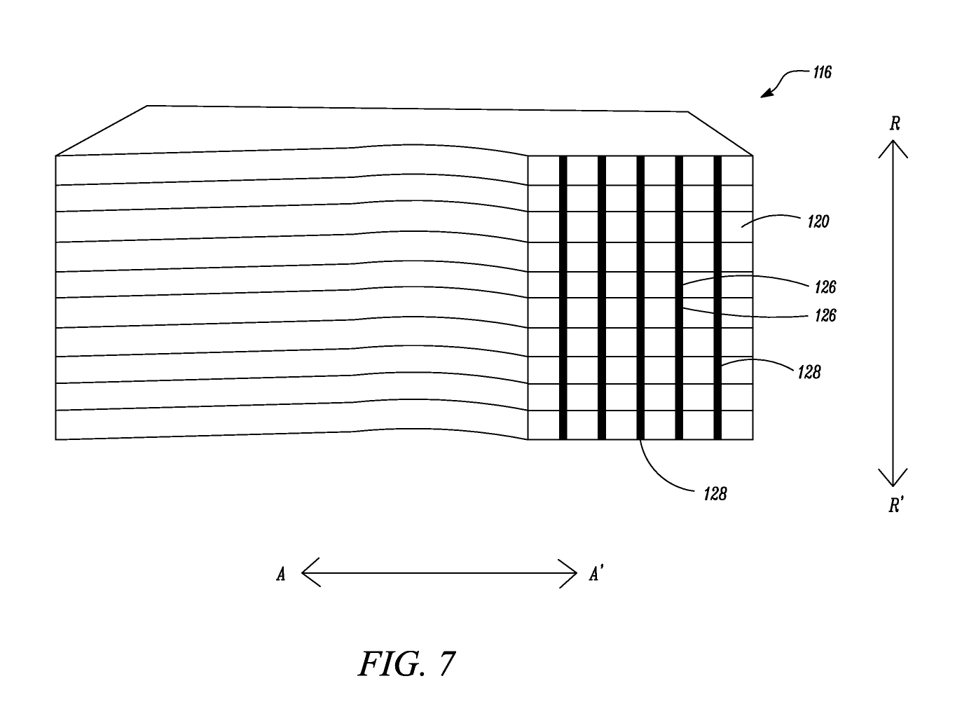

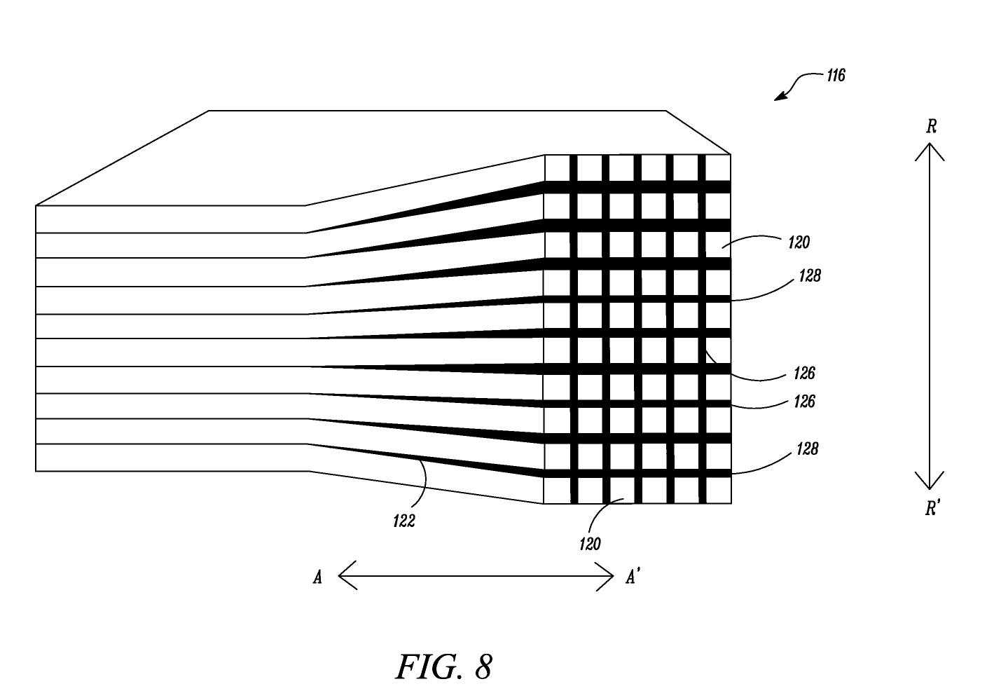

FIGS. 6-8 illustrate various views of the stator winding 116, according to other aspects of the present disclosure. In these embodiments, the stator winding 116 is illustrated with plates 128 inserted between the adjacent coils 120 at the end turns 122, such that each of the gaps 124 is filled with a plate 128. The plates 128 may have a curvilinear profile to be in contact with the inner faces 126, conforming to the shape of the coils 120 at the end turn 122. In an embodiment, the plates 128 may be extending beyond the end turns 122 to provide more surface to be in reach of the cooling fluid. The plates 128 may extend as fins (not illustrated) in the axial direction A-A′ or the radial direction R-R′ or both.

For the purpose of the present disclosure, the plates 128 may be made of thermally conducting material like copper or aluminum. The plates 128 may allow the conduction of the heat from the coils 120 at centre of the stator winding 116 to the coils 120 at outer periphery of the stator winding 116, which may be in direct reach of the cooling fluid. Specifically, the plates 128 may allow the conduction of the heat from the inner faces 126 of the coils 120 to the outer periphery of the stator winding 116. In an embodiment, the plates 128 may include a coat of thermally conductive epoxy material to further increase the conduction of heat. It may be understood that, the plates 128 may be electrically insulated to avoid shorting between the coils 120 of the stator winding 116.

### INDUSTRIAL APPLICABILITY

Inherently, in operation, heat is generated by losses in the stator windings 116 of the electric machine 100. These losses are due to electrical or ohmic resistance in the stator windings 116, which may generate heat. Further, alternating magnetic flux in the stator core 106 causes iron losses (eddy currents and hysteresis) which may also generate heat. For effective operation of the electric machine 100, the heat needs to be removed.

Typically, the electric machine 100 incorporates a cooling system (not illustrated) for cooling of various components of the electric machine 100. The cooling system may employ different cooling methods to achieve the purpose. The cooling system may utilize the cooling fluid to pass over the various components in the electric machine 100, and in the process may extract heat from the various components. The cooling system may be able to effectively cool the components in direct contact with the cooling fluid, but may not be able to extract heat from the components not in direct reach of the cooling fluid. In particular, the cooling system may not be able to effectively cool the inner faces 126 of the coils 120 in the stator winding 116.

To overcome this limitation of the cooling system, the electric machine 100 of the present disclosure includes the gaps 124 defined between the coils 120. When the cooling fluid is sprayed or flooded over the stator 102, the cooling fluid flows through the stator winding 116, and the gaps 124 may allow the cooling fluid to reach the inner faces 126 in the stator winding 116. This ensures more uniform and effective cooling of the various components in the electric machine 100.

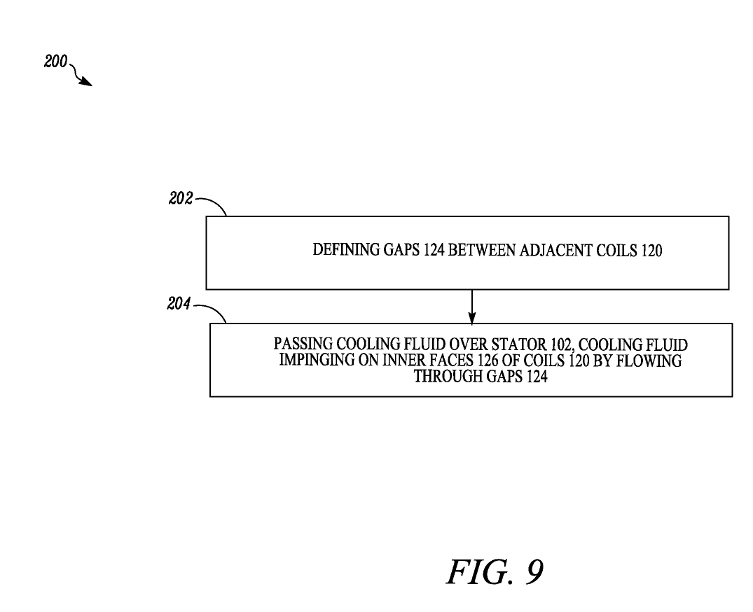

FIG. 9 illustrates a process flow 200 for cooling of the electric machine 100. As illustrated in step 202, the gaps 124 are defined between the adjacent coils 120. To define the gaps 124, the stator winding 116 may be formed by successively winding the electrically conductive wire in the radial direction R-R′ as well as the axial direction A-A′. The electrically conductive wire may be sequentially wound for a predetermined number of turns. While winding the electrically conductive wire, spacers (not illustrated) may be inserted between the adjacent coils 120 at the end turns 122 after completing each turn. Further, the spacers may be removed to define the gaps 124 between the coils 120 at the end turns 122. In an embodiment with the spacers made of thermally conductive material, the spacers may act as the plates 128 for the stator winding 116. In such an embodiment, the spacers may be left between the coils 120 after forming of the stator winding 116.

Further in step 204, a cooling fluid is passed over the stator 102, which may flow through the stator winding 116 and the gaps 124. This may enable the cooling system to directly impinge the cooling fluid on the inner faces 126 of the coils 120 through the gaps 124. Thus, the cooling fluid may be able to extract the heat from the inner faces 126 of the coils 120 in the stator winding 116.

Finally, the cooling fluid may be removed from the stator 102 in the electric machine 100. In the process, the cooling fluid may take away the heat and thus cools the electric machine 100. The cooling fluid may be re-circulated in the electric machine 100 by the cooling system, after being cooled down by some methods known in the art.

It should be noted that although the disclosed embodiments are described by way of reference to the switched reluctance motor, it will be appreciated that such references are considered exemplary only and the disclosed embodiments may be applied to any electric machine 100. The exemplary embodiments herein referring to the electric machine 100 including, but not limited to, motors, or more specifically switched reluctance motors, hereafter may be made to electric generators without any limitation.

Although the embodiments of this disclosure as described herein may be incorporated without departing from the scope of the following claims, it will be apparent to those skilled in the art that various modifications and variations can be made. Other embodiments will be apparent to those skilled in the art from consideration of the specification and practice of the disclosure. It is intended that the specification and examples be considered as exemplary only, with a true scope being indicated by the following claims and their equivalents.

What is claimed is:

1. A stator comprising:
a stator core having a plurality of stator poles protruding in a radial direction;
a stator winding wound around each of the stator poles, the stator winding having multiple coils and an end turn positioned at each axial end thereof; and
a gap provided between adjacent coils at the end turns to allow a cooling fluid to pass.

2. The stator of claim 1, wherein the stator winding is formed by successively winding an electrically conductive wire in the radial direction and an axial direction around the stator poles.

3. The stator of claim 2, wherein the gaps are provided between the adjacent coils in the radial direction.

4. The stator of claim 2, wherein the gaps are provided between the adjacent coils in the axial direction.

5. The stator of claim 2, wherein the gaps are provided between the adjacent coils in both the radial direction and the axial direction.

6. The stator of claim 1 further including plates disposed between the adjacent coils, wherein the plates fill the gaps.

7. The stator of claim 6 further including the plates extend beyond the end turns in a one of the radial direction and an axial direction.

8. The stator of claim 6, wherein the plates include thermally conductive material, and wherein the plates are electrically insulated.

9. An electric machine comprising:
a stator core having a plurality of stator poles protruding in a radial direction;
a rotor core having a plurality of rotor poles protruding in the radial direction;
a stator winding wound around each of the stator poles, the stator winding having multiple coils and an end turn positioned at each axial end thereof; and
a gap provided between adjacent coils at the end turns to allow a cooling fluid to pass.

10. The electric machine of claim 9 is a switched reluctance motor.

11. The electric machine of claim 9, wherein the stator winding is formed by successively winding an electrically conductive wire in the radial direction and an axial direction around the stator pole.

12. The electric machine of claim 11, wherein the gaps are provided between the adjacent coils in the radial direction.

13. The electric machine of claim 11, wherein the gaps are provided between the adjacent coils in the axial direction.

14. The electric machine of claim 11, wherein the gaps are provided between the adjacent coils in both the radial direction and the axial direction.

15. The electric machine of claim 9 further including plates disposed between the adjacent coils, wherein the plates fill the gaps.

16. The electric machine of claim 15 further including the plates extend beyond the end turns in a one of the radial direction and an axial direction.

17. The electric machine of claim 15, wherein the plates include thermally conductive material, and wherein the plates are electrically insulated.

18. A method of cooling an electric machine having a stator, the stator having a stator winding disposed over a stator pole, the stator winding having multiple coils, the method comprising:
defining gaps between the adjacent coils; and
passing a cooling fluid over the stator, the cooling fluid impinging on inner faces of the coils by flowing through the gaps.

19. The method of claim 18 includes inserting plates between the adjacent coils; wherein the plates fill the gaps.

20. The method of claim 18 further includes removing the cooling fluid from the stator.
